(19) United States
(12) Patent Application Publication
(10) Pub. No.: US 2018/0060635 A1
(43) Pub. Date: Mar. 1, 2018

(54) POINT SPREAD FUNCTION ESTIMATION AND DECONVOLUTION-BASED DISTORTION REMOVAL

(71) Applicant: QUALCOMM Incorporated, San Diego, CA (US)

(72) Inventors: Ren Li, San Diego, CA (US); Hyun Jin Park, San Diego, CA (US); Nathan Altman, San Diego, CA (US)

(21) Appl. No.: 15/253,729

(22) Filed: Aug. 31, 2016

(51) Int. Cl. G06K 9/00

(52) U.S. Cl. CPC G06K 9/0002; G06K 9/00067

(57) ABSTRACT

One aspect of the subject matter described may be implemented in a system for use in obtaining a deconvolved image of an object. In some implementations, the system may include an ultrasonic sensing system configured to perform an ultrasonic image scanning operation including one or more image scans of an object to obtain at least one measured image of the object. The system may include a processing unit configured to determine an initial estimate of a point spread function (PSF) associated with the ultrasonic image scanning operation based on the measured image. The processing unit may be configured to determine an initial estimate of a deconvolved image of the object based on the initial estimate of the PSF. The processing unit may be further configured to determine a refined estimate of the deconvolved image using an iterative deconvolution operation based on the initial estimates of the PSF and the deconvolved image.

### TECHNICAL FIELD

This disclosure relates generally to ultrasonic image processing, and more particularly, to estimating a point spread function associated with an ultrasonic imaging operation and using the estimated point spread function in an iterative deconvolution operation to remove distortion from an image.

### DESCRIPTION OF RELATED TECHNOLOGY

Many mobile devices, display devices and other electronic devices include fingerprint sensors, and the number and variety of devices that include fingerprint sensors and other biometric sensors continues to grow. Ultrasonic imaging technology is being investigated for use in such fingerprint and other biometric sensors. However, ultrasonic images, especially in devices with a thick platen, have traditionally suffered from one, some or all of low image quality, low signal-to-noise ratio (SNR), low resolution, low contrast, attenuation and speckle noise. Ultrasonic fingerprint images in particular can suffer from image blurring artifacts in the form of, for example, clouding and phase inversion defects or other distortions. Such distortions can result from the passage of ultrasonic pressure waves, including both the incident scanning waves as well as the reflected waves, as these waves travel through the platen overlying the fingerprint sensor onto which the finger is pressed during an ultrasonic imaging scan. As the ultrasonic waves propagate through the platen, the waves can be subjected to beam spreading, refraction, diffraction and interference resulting in distortion.

### SUMMARY

The systems, methods and devices of this disclosure each have several aspects, no single one of which is solely responsible for the desirable attributes disclosed herein. One aspect of the subject matter described in this disclosure may be implemented in a method for use by a processing unit in obtaining a deconvolved image of an object. The method may include determining an initial estimate of a point spread function (PSF) associated with an ultrasonic image scanning operation based on at least one measured image of the object from the ultrasonic image scanning operation. The method may include determining an initial estimate of a deconvolved image of the object based on the initial estimate of the PSF. The method may further include determining a refined estimate of the deconvolved image of the object using an iterative deconvolution operation based on the initial estimate of the PSF and the initial estimate of the deconvolved image.

Another aspect of the subject matter described in this disclosure may be implemented in a system for use in obtaining a deconvolved image of an object. The system may include an ultrasonic sensing system configured to perform an ultrasonic image scanning operation including one or more image scans of an object to obtain at least one measured image of the object. The system may include a processing unit configured to determine an initial estimate of a point spread function (PSF) associated with the ultrasonic image scanning operation based on the at least one measured image. The processing unit may be configured to determine an initial estimate of a deconvolved image of the object based on the initial estimate of the PSF. The processing unit may be further configured to determine a refined estimate of the deconvolved image of the object using an iterative deconvolution operation based on the initial estimate of the PSF and the initial estimate of the deconvolved image.

Another aspect of the subject matter described in this disclosure may be implemented in one or more tangible computer-readable media including processor-executable instructions for determining an initial estimate of a point spread function (PSF) associated with an ultrasonic image scanning operation based on at least one measured image of the object from the ultrasonic image scanning operation. The computer-readable media may include processor-executable instructions for determining an initial estimate of a deconvolved image of the object based on the initial estimate of the PSF. The computer-readable media may further include processor-executable instructions for determining a refined estimate of the deconvolved image of the object using an iterative deconvolution operation based on the initial estimate of the PSF and the initial estimate of the deconvolved image.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a front view of a diagrammatic representation of an example mobile device that includes an ultrasonic sensing system according to some implementations.

FIG. 2A shows a block diagram representation of components of an example ultrasonic sensing system according to some implementations.

FIG. 2B shows a block diagram representation of components of an example mobile device that includes the ultrasonic sensing system of FIG. 2A.

FIG. 3A shows a cross-sectional projection view of a diagrammatic representation of a portion of an example ultrasonic sensing system according to some implementations.

FIG. 3B shows a zoomed-in cross-sectional side view of the example ultrasonic sensing system of FIG. 3A according to some implementations.

FIG. 4 shows an exploded projection view of example components of the example ultrasonic sensing system of FIGS. 3A and 3B according to some implementations.

FIG. 5 shows a flowchart illustrating an example process for identifying an object signature according to some implementations.

FIG. 6 shows a flowchart illustrating an example process for performing an image scanning operation according to some implementations.

FIG. 7 shows a flowchart illustrating an example process for performing an initial PSF estimation operation according to some implementations.

FIG. 8 shows a flowchart illustrating an example process for performing an iterative MAP-based operation according to some implementations.

Like reference numbers and designations in the various drawings indicate like elements.

### DETAILED DESCRIPTION

The following description is directed to certain implementations for the purposes of describing various aspects of this disclosure. However, a person having ordinary skill in the art will readily recognize that the teachings herein may be applied in a multitude of different ways. Some of the concepts and examples provided in this disclosure are especially applicable to ultrasonic fingerprint sensing systems and related applications. However, some implementations may be applicable to other types of ultrasonic sensing systems including other types of biometric sensing systems as well as non-biometric sensing systems, and even to other non-ultrasonic based sensing systems. As such, the teachings are not intended to be limited to the specific implementations depicted and described with reference to the Figures; rather, the teachings have wide applicability as will be apparent to persons having ordinary skill in the art.

This disclosure relates generally to devices, systems and methods for removing distortion from images. Various implementations are more particularly directed or applicable to devices, systems and methods for estimating a point spread function (PSF) associated with an imaging operation and using the estimated PSF in an image distortion removal operation. Some implementations more specifically relate to devices, systems and methods for estimating a PSF associated with an ultrasonic imaging operation, including a component associated with the ultrasonic sensing system that performs the ultrasonic imaging operation. Some implementations more specifically relate to devices, systems and methods for estimating the PSF on a dynamic basis, and in some particular implementations, in approximately real time. Some implementations more specifically relate to devices, systems and methods for using the estimated PSF in a deconvolution operation to remove the distortion. Some implementations more specifically relate to performing the deconvolution operation using an iterative maximum a posteriori (MAP)-based operation. In some such implementations, the MAP-based operation includes minimizing an augmented Lagrangian method (ALM)-based cost function.

Particular implementations of the subject matter described in this disclosure may be implemented to realize one or more of the following potential advantages. Some implementations provide the ability to estimate a PSF in substantially real time based on a measured image and to remove distortion from the image in substantially real time based on the estimated PSF. Some such implementations provide the ability to accurately obtain a fingerprint image in substantially real time and to authenticate a corresponding user based on the fingerprint image. Some implementations provide the ability to estimate the PSF and to remove the distortion using the PSF regardless of the properties of the platen overlying the sensors of the imaging system. Some implementations provide the ability to estimate the PSF and to remove the distortion using the PSF regardless of dynamic changes in material or acoustic properties due to, for example, increases or decreases in temperature. Some implementations enable rapid convergence of an iterative MAP-based deconvolution operation based on a refined initial estimate of the PSF and an initial estimate of the true image.

As used herein, the term “biometric” refers to a measurement of a physical, biological attribute. As used herein, the term “biometric sensor” refers to a device capable of measuring at least one biometric attribute. As used herein, the term “biometric sensing system” refers to a physical apparatus that includes at least one biometric sensor and that is capable of measuring a biometric attribute using the at least one biometric sensor.

As used herein, the terms “ultrasound” and “ultrasonic wave” are used interchangeably and refer to a propagating pressure wave having a frequency greater than or equal to about 20 kilohertz (kHz), and in some implementations, in the range of about 1 Megahertz (MHz) and about 100 MHz. As used herein, the terms “ultrasound sensor,” “ultrasound transducer,” “ultrasonic sensor,” and “ultrasonic transducer” are used interchangeably and refer to a device capable of generating ultrasonic waves based on electrical data, and capable of receiving ultrasonic waves and providing electrical data based on the received ultrasonic waves. As used herein, the terms “ultrasound sensing system,” and “ultrasonic sensing system” are used interchangeably and refer to a physical apparatus that includes at least one ultrasonic sensor and that is capable of measuring a biometric attribute using the at least one ultrasonic sensor.

As used herein, the terms “imaging” and “sensing” are used interchangeably where appropriate unless otherwise indicated and refer to a set of one or more operations for scanning an object using ultrasonic waves, for receiving or detecting reflected, refracted or scattered ultrasonic waves, and for generating or providing image data based on the received ultrasonic waves usable to provide an image of the object. As used herein, the term “image” refers to a data structure or collection of data that includes data capable of being rendered, or otherwise processed and rendered, into a depiction or a representation of an actual object, such as a fingerprint. As used herein, the term “measured image” refers to an image, whether raw or processed, obtained using an ultrasonic sensing system prior to a distortion removal operation. As used herein, the term “distorted image” refers to a measured image that includes distortion. As used herein, the terms “true image” and “actual image” are used interchangeably and refer to an image of an object having no distortion. As used herein, the term “deconvolved image” refers to an image obtained after deconvolving a PSF associated with an imaging operation from a measured image of an object.

As used herein, the terms “processor,” “processing unit,” “controller” and “control unit” are used interchangeable and refer to one or more distinct control units or processing units in electrical communication with one another. In some implementations, a processing unit may include one or more of a general purpose single- or multi-chip processor, a central processing unit (CPU), a digital signal processor (DSP), an applications processor, an application specific integrated circuit (ASIC), a field programmable gate array (FPGA) or other programmable logic device (PLD), discrete gate or transistor logic, discrete hardware components, or any combination thereof designed to perform the functions and operations described herein.

As used herein, the terms “device” and “system” are used interchangeably and refer to a physical apparatus that may include a variety of hardware components including discrete logic and other electrical components, as well as components such as computer readable media that may store software or firmware and components such as processors that may execute or otherwise implement software or firmware. As used herein, the terms “mobile device,” “mobile computing device,” “portable computing device” and “computing device” are used interchangeably.

As used herein, the terms “estimating,” “calculating,” “inferring,” “deducing,” “evaluating” and “determining” may be used interchangeably herein where appropriate unless otherwise indicated. Similarly, derivations from the roots of these terms may be used interchangeably where appropriate; for example, the terms “estimation,” “calculation,” “inference” and “determination” may be used interchangeably herein. Additionally, the phrase “capable of” may be used interchangeably with the phrases “configured to,” “operable to,” “adapted to,” “manufactured to,” and “programmed to” where appropriate unless otherwise indicated.

Also of note, the conjunction “or” as used herein is intended in the inclusive sense where appropriate unless otherwise indicated; that is, the phrase “A, B or C” is intended to include the possibilities of A individually; B individually; C individually; A and B and not C; B and C and not A; A and C and not B; and A and B and C. Similarly, a phrase referring to “at least one of” a list of items refers to any combination of those items, including single members. As an example, the phrase “at least one of A, B, or C” is intended to cover the possibilities of at least one of A; at least one of B; at least one of C; at least one of A and at least one of B; at least one of B and at least one of C; at least one of A and at least one of C; and at least one of A, at least one of B and at least one of C.

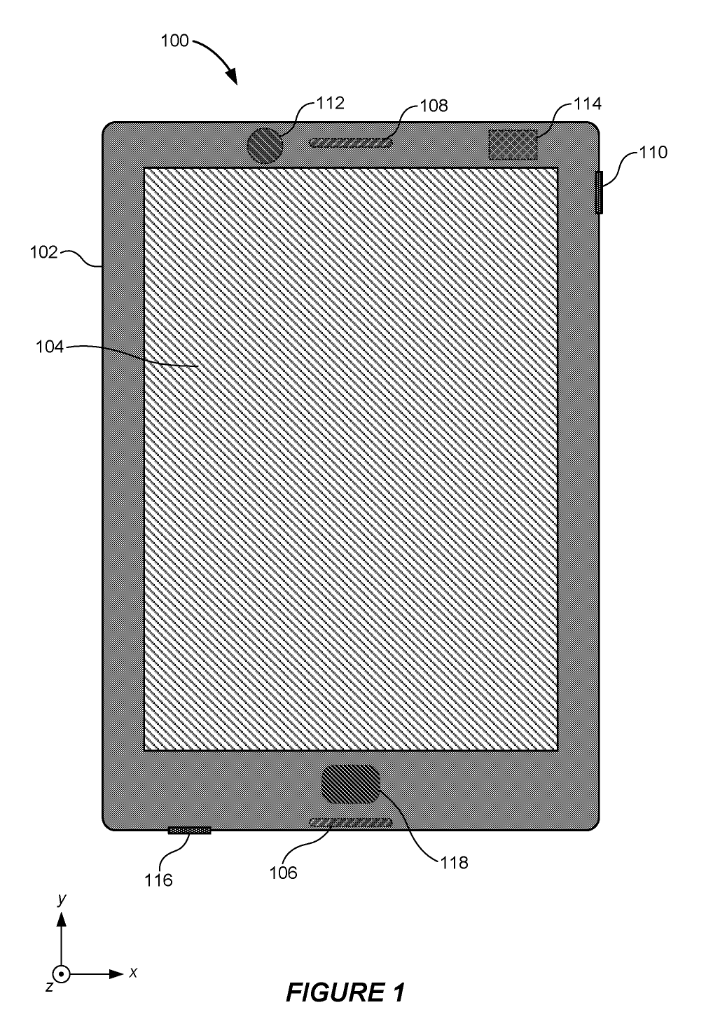

FIG. 1 shows a diagrammatic representation of an example mobile device 100 that includes an ultrasonic sensing system according to some implementations. The mobile device 100 may be representative of, for example, various portable computing devices such as cellular phones, smartphones, multimedia devices, personal gaming devices, tablet computers and laptop computers, among other types of portable computing devices. However, various implementations described herein are not limited in application to portable computing devices. Indeed, various techniques and principles disclosed herein may be applied in traditionally non-portable devices and systems, such as in computer monitors, television displays, kiosks, vehicle navigation devices and audio systems, among other applications. Additionally, various implementations described herein are not limited in application to devices that include displays.

The mobile device 100 generally includes a housing (or “case”) 102 within which various circuits, sensors and other electrical components reside. In the illustrated example implementation, the mobile device 100 also includes a touchscreen display (also referred to herein as a “touch-sensitive display”) 104. The touchscreen display 104 generally includes a display and a touchscreen arranged over or otherwise incorporated into or integrated with the display. The display 104 may generally be representative of any of a variety of suitable display types that employ any of a variety of suitable display technologies. For example, the display 104 may be a digital micro-shutter (DMS)-based display, a light-emitting diode (LED) display, an organic LED (OLED) display, a liquid crystal display (LCD), an LCD display that uses LEDs as backlights, a plasma display, an interferometric modulator (IMOD)-based display, or another type of display suitable for use in conjunction with touch-sensitive user interface (UI) systems.

The mobile device 100 may include various other devices or components for interacting with, or otherwise communicating information to or receiving information from, a user. For example, the mobile device 100 may include one or more microphones 106, one or more speakers 108, and in some cases one or more at least partially mechanical buttons 110. The mobile device 100 may include various other components enabling additional features such as, for example, one or more video or still-image cameras 112, one or more wireless network interfaces 114 (for example, Bluetooth, WiFi or cellular) and one or more non-wireless interfaces 116 (for example, a universal serial bus (USB) interface or an HDMI interface).

The mobile device 100 may include an ultrasonic sensing system 118 capable of scanning and imaging an object signature, such as a fingerprint, palm print or handprint. In some implementations, the ultrasonic sensing system 118 may function as a touch-sensitive control button. In some implementations, a touch-sensitive control button may be implemented with a mechanical or electrical pressure-sensitive system that is positioned under or otherwise integrated with the ultrasonic sensing system 118. In other words, in some implementations, a region occupied by the ultrasonic sensing system 118 may function both as a user input button to control the mobile device 100 as well as a fingerprint sensor to enable security features such as user authentication features.

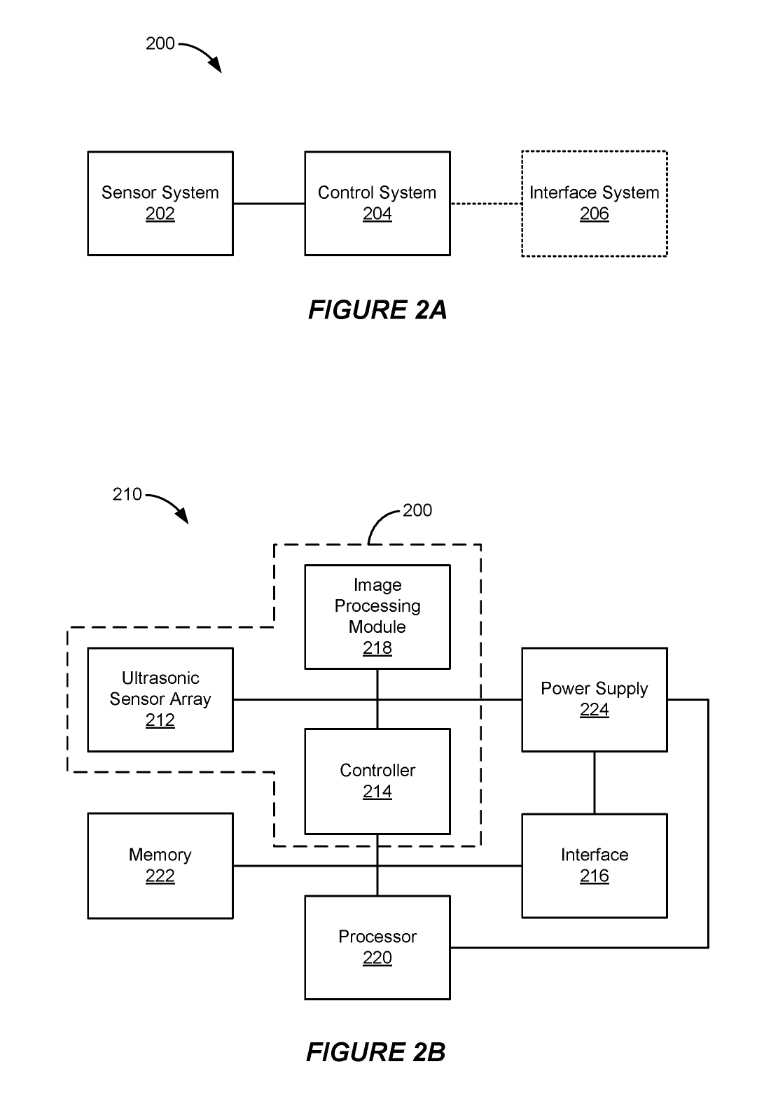

FIG. 2A shows a block diagram representation of components of an example ultrasonic sensing system 200 according to some implementations. As shown, the ultrasonic sensing system 200 may include a sensor system 202 and a control system 204 electrically coupled to the sensor system 202. The sensor system 202 may be capable of scanning an object and providing raw measured image data usable to obtain an object signature, for example, such as a fingerprint of a human finger. The control system 204 may be capable of controlling the sensor system 202 and processing the raw measured image data received from the sensor system. In some implementations, the ultrasonic sensing system 200 may include an interface system 206 capable of transmitting or receiving data, such as raw or processed measured image data, to or from various components within or integrated with the ultrasonic sensing system 200 or, in some implementations, to or from various components, devices or other systems external to the ultrasonic sensing system.

FIG. 2B shows a block diagram representation of components of an example mobile device 210 that includes the ultrasonic sensing system 200 of FIG. 2A. For example, the mobile device 210 may be a block diagram representation of the mobile device 100 shown in and described with reference to FIG. 1 above. The sensor system 202 of the ultrasonic sensing system 200 of the mobile device 210 may be implemented with an ultrasonic sensor array 212. The control system 204 of the ultrasonic sensing system 200 may be implemented with a controller 214 that is electrically coupled to the ultrasonic sensor array 212. While the controller 214 is shown and described as a single component, in some implementations, the controller 214 may collectively refer to two or more distinct control units or processing units in electrical communication with one another. In some implementations, the controller 214 may include one or more of a general purpose single- or multi-chip processor, a central processing unit (CPU), a digital signal processor (DSP), an applications processor, an application specific integrated circuit (ASIC), a field programmable gate array (FPGA) or other programmable logic device (PLD), discrete gate or transistor logic, discrete hardware components, or any combination thereof designed to perform the functions and operations described herein.

The ultrasonic sensing system 200 of FIG. 2B may include an image processing module 218. In some implementations, raw measured image data provided by the ultrasonic sensor array 212 may be sent, transmitted, communicated or otherwise provided to the image processing module 218. The image processing module 218 may include any suitable combination of hardware, firmware and software configured, adapted or otherwise operable to process the image data provided by the ultrasonic sensor array 212. In some implementations, the image processing module 218 may include signal or image processing circuits or circuit components including, for example, amplifiers (such as instrumentation amplifiers or buffer amplifiers), analog or digital mixers or multipliers, switches, analog-to-digital converters (ADCs), passive or active analog filters, among others. In some implementations, one or more of such circuits or circuit components may be integrated within the controller 214, for example, where the controller 214 is implemented as a system-on-chip (SoC) or system-in-package (SIP). In some implementations, one or more of such circuits or circuit components may be integrated within a DSP included within or coupled to the controller 214. In some implementations, the image processing module 218 may be implemented at least partially via software. For example, one or more functions of, or operations performed by, one or more of the circuits or circuit components just described may instead be performed by one or more software modules executing, for example, in a processing unit of the controller 214 (such as in a general purpose processor or a DSP).

In some implementations, in addition to the ultrasonic sensing system 200, the mobile device 210 may include a separate processor 220, a memory 222, an interface 216 and a power supply 224. In some implementations, the controller 214 of the ultrasonic sensing system 200 may control the ultrasonic sensor array 212 and the image processing module 218, and the processor 220 of the mobile device 210 may control other components of the mobile device 210. In some implementations, the processor 220 communicates data to the controller 214 including, for example, instructions or commands. In some such implementations, the controller 214 may communicate data to the processor 220 including, for example, raw or processed image data. It should also be understood that, in some other implementations, the functionality of the controller 214 may be implemented entirely, or at least partially, by the processor 220. In some such implementations, a separate controller 214 for the ultrasonic sensing system 200 may not be required because the functions of the controller 214 may be performed by the processor 220 of the mobile device 210.

Depending on the implementation, one or both of the controller 214 and processor 220 may store data in the memory 222. For example, the data stored in the memory 222 may include raw measured image data, filtered or otherwise processed image data, estimated PSF or estimated image data, and final refined PSF or final refined image data. The memory 222 may store processor-executable code or other executable computer-readable instructions capable of execution by one or both of the controller 214 and the processor 220 to perform various operations (or to cause other components such as the ultrasonic sensor array 212, the image processing module 218, or other modules to perform operations), including any of the calculations, computations, estimations or other determinations described herein (including those presented in any of the equations below). It should also be understood that the memory 222 may collectively refer to one or more memory devices (or “components”). For example, depending on the implementation, the controller 214 may have access to and store data in a different memory device than the processor 220. In some implementations, one or more of the memory components may be implemented as a NOR- or NAND-based Flash memory array. In some other implementations, one or more of the memory components may be implemented as a different type of non-volatile memory. Additionally, in some implementations, one or more of the memory components may include a volatile memory array such as, for example, a type of RAM.

In some implementations, the controller 214 or the processor 220 may communicate data stored in the memory 222 or data received directly from the image processing module 218 through an interface 216. For example, such communicated data can include image data or data derived or otherwise determined from image data. The interface 216 may collectively refer to one or more interfaces of one or more various types. In some implementations, the interface 216 may include a memory interface for receiving data from or storing data to an external memory such as a removable memory device. Additionally or alternatively, the interface 216 may include one or more wireless network interfaces or one or more wired network interfaces enabling the transfer of raw or processed data to, as well as the reception of data from, an external computing device, system or server.

A power supply 224 may provide power to some or all of the components in the mobile device 210. The power supply 224 may include one or more of a variety of energy storage devices. For example, the power supply 224 may include a rechargeable battery, such as a nickel-cadmium battery or a lithium-ion battery. Additionally or alternatively, the power supply 224 may include one or more supercapacitors. In some implementations, the power supply 224 may be chargeable (or “rechargeable”) using power accessed from, for example, a wall socket (or “outlet”) or a photovoltaic device (or “solar cell” or “solar cell array”) integrated with the mobile device 210. Additionally or alternatively, the power supply 224 may be wirelessly chargeable.

As used hereinafter, the term “processing unit” refers to any combination of one or more of a controller of an ultrasonic system (for example, the controller 214), an image processing module (for example, the image processing module 218), or a separate processor of a device that includes the ultrasonic system (for example, the processor 220). In other words, operations that are described below as being performed by or using a processing unit may be performed by one or more of a controller of the ultrasonic system, an image processing module, or a separate processor of a device that includes the ultrasonic sensing system.

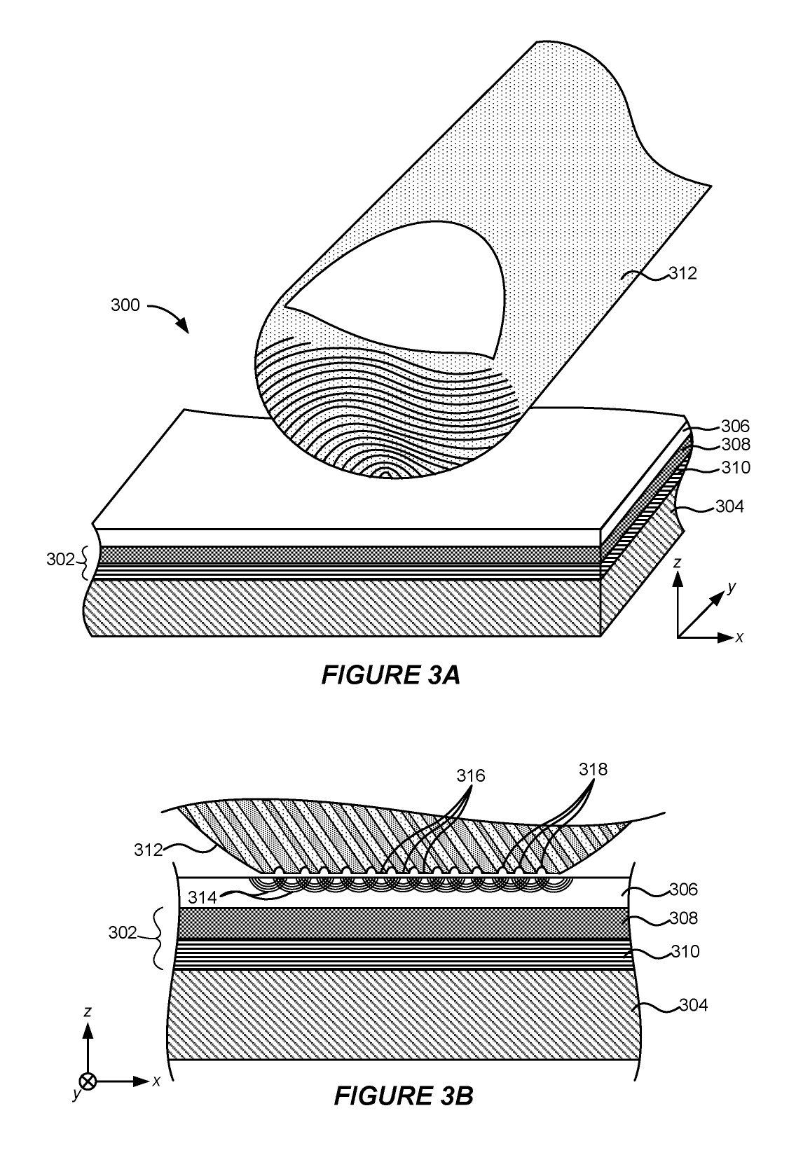

FIG. 3A shows a cross-sectional projection view of a diagrammatic representation of a portion of an example ultrasonic sensing system 300 according to some implementations. FIG. 3B shows a zoomed-in cross-sectional side view of the example ultrasonic sensing system 300 of FIG. 3A according to some implementations. For example, the ultrasonic sensing system 300 may implement the ultrasonic sensing system 118 described with reference to FIG. 1 or the ultrasonic sensing system 200 shown and described with reference to FIGS. 2A and 2B. The ultrasonic sensing system 300 may include an ultrasonic transducer 302 that overlies a substrate 304 and that underlies a platen (a “cover plate” or “cover glass”) 306. The ultrasonic transducer 302 may include both an ultrasonic transmitter 308 and an ultrasonic receiver 310.

The ultrasonic transmitter 308 is generally configured to generate ultrasonic waves towards the platen 306, and in the illustrated implementation, towards a human finger positioned on the upper surface of the platen. In some implementations, the ultrasonic transmitter 308 may more specifically be configured to generate ultrasonic plane waves towards the platen 306. In some implementations, the ultrasonic transmitter 308 includes a layer of piezoelectric material such as, for example, polyvinylidene fluoride (PVDF) or a PVDF copolymer such as PVDF-TrFE. For example, the piezoelectric material of the ultrasonic transmitter 308 may be configured to convert electrical signals provided by the controller of the ultrasonic sensing system into a continuous or pulsed sequence of ultrasonic plane waves at a scanning frequency. In some implementations, the ultrasonic transmitter 308 may additionally or alternatively include capacitive ultrasonic devices.

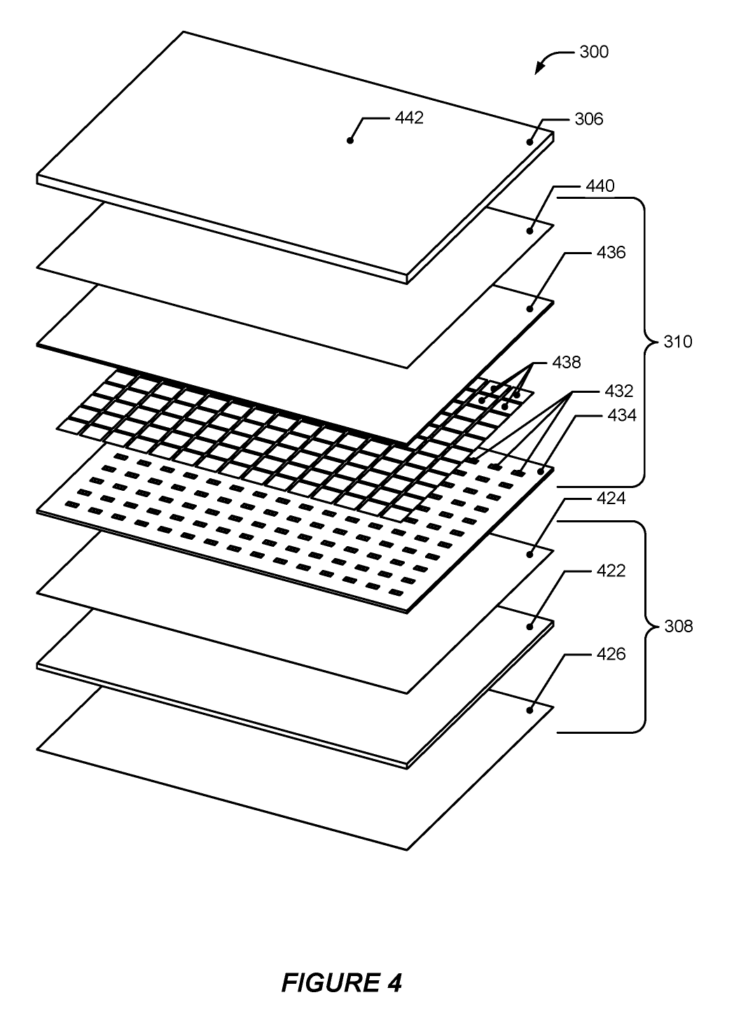

The ultrasonic receiver 310 is generally configured to detect ultrasonic reflections 314 resulting from interactions of the ultrasonic waves transmitted by the ultrasonic transmitter 308 with ridges 316 and valleys 318 defining the fingerprint of the finger 312 being scanned. In some implementations, the ultrasonic transmitter 308 overlies the ultrasonic receiver 310 as, for example, illustrated in FIGS. 3A and 3B. In some other implementations, the ultrasonic receiver 310 may overlie the ultrasonic transmitter 308 (as shown in FIG. 4 described below). The ultrasonic receiver 310 may be configured to generate and output electrical output signals corresponding to the detected ultrasonic reflections. In some implementations, the ultrasonic receiver 310 may include a second piezoelectric layer different than the piezoelectric layer of the ultrasonic transmitter 308. For example, the piezoelectric material of the ultrasonic receiver 310 may be any suitable piezoelectric material such as, for example, a layer of PVDF or a PVDF copolymer. The piezoelectric layer of the ultrasonic receiver 310 may convert vibrations caused by the ultrasonic reflections into electrical output signals. In some implementations, the ultrasonic receiver 310 further includes a thin-film transistor (TFT) layer. In some such implementations, the TFT layer may include an array of sensor pixel circuits configured to amplify the electrical output signals generated by the piezoelectric layer of the ultrasonic receiver 310. The amplified electrical signals provided by the array of sensor pixel circuits may then be provided as raw measured image data to the processing unit for use in processing the image data, identifying a fingerprint associated with the image data, and in some applications, authenticating a user associated with the fingerprint. In some implementations, a single piezoelectric layer may serve as the ultrasonic transmitter 308 and the ultrasonic receiver 310. In some implementations, the substrate 304 may be a glass, plastic or silicon substrate upon which electronic circuitry may be fabricated. In some implementations, an array of sensor pixel circuits and associated interface circuitry of the ultrasonic receiver 310 may be configured from CMOS circuitry formed in or on the substrate 304. In some implementations, the substrate 304 may be positioned between the platen 306 and the ultrasonic transmitter 308 and/or the ultrasonic receiver 310. In some implementations, the substrate 304 may serve as the platen 306. One or more protective layers, acoustic matching layers, anti-smudge layers, adhesive layers, decorative layers, conductive layers or other coating layers (not shown) may be included on one or more sides of the substrate 304 and the platen 306.

The platen 306 may be formed of any suitable material that may be acoustically coupled to the ultrasonic transmitter 308. For example, the platen 306 may be formed of one or more of glass, plastic, ceramic, sapphire, metal or metal alloy. In some implementations, the platen 306 may be a cover plate such as, for example, a cover glass or a lens glass of an underlying display. In some implementations, the platen 306 may include one or more polymers, such as one or more types of parylene, and may be substantially thinner. In some implementations, the platen 306 may have a thickness in the range of about 10 microns (μm) to about 1000 μm or more.

In some implementations, the ultrasonic sensing system 300 may further include a focusing layer (not shown). For example, the focusing layer may be positioned above the ultrasonic transmitter 308. The focusing layer may generally include one or more acoustic lenses capable of altering the paths of ultrasonic waves transmitted by the ultrasonic transmitter 308. In some implementations, the lenses may be implemented as cylindrical lenses, spherical lenses or zone lenses. In some implementations, some or all of the lenses may be concave lenses, whereas in some other implementations some or all of the lenses may be convex lenses, or include a combination of concave and convex lenses.

In some implementations that include such a focusing layer, the ultrasonic sensing device 300 may additionally include an acoustic matching layer to ensure proper acoustic coupling between the focusing lens(es) and an object, such as a finger, positioned on the platen 306. For example, the acoustic matching layer may include an epoxy doped with particles that change the density of the acoustic matching layer. If the density of the acoustic matching layer is changed, then the acoustic impedance will also change according to the change in density, if the acoustic velocity remains constant. In alternative implementations, the acoustic matching layer may include silicone rubber doped with metal or with ceramic powder. In some implementations, sampling strategies for processing output signals may be implemented that take advantage of ultrasonic reflections being received through a lens of the focusing layer. For example, an ultrasonic wave coming back from a lens' focal point will travel into the lens and may propagate towards multiple receiver elements in a receiver array fulfilling the acoustic reciprocity principle. Depending on the signal strength coming back from the scattered field, an adjustment of the number of active receiver elements is possible. In general, the more receiver elements that are activated to receive the returned ultrasonic waves, the higher the signal-to-noise ratio (SNR). In some implementations, one or more acoustic matching layers may be positioned on one or both sides of the platen 306, with or without a focusing layer.

FIG. 4 shows an exploded projection view of example components of the example ultrasonic sensing system 300 of FIGS. 3A and 3B according to some implementations. The ultrasonic transmitter 308 may include a substantially planar piezoelectric transmitter layer 422 capable of functioning as a plane wave generator. Ultrasonic waves may be generated by applying a voltage across the piezoelectric transmitter layer 422 to expand or contract the layer, depending upon the voltage signal applied, thereby generating a plane wave. In this example, the processing unit (not shown) is capable of causing a transmitter excitation voltage to be applied across the piezoelectric transmitter layer 422 via a first transmitter electrode 424 and a second transmitter electrode 426. The first and second transmitter electrodes 424 and 426 may be metallized electrodes, for example, metal layers that coat opposing sides of the piezoelectric transmitter layer 422. As a result of the piezoelectric effect, the applied transmitter excitation voltage causes changes in the thickness of the piezoelectric transmitter layer 422, and in such a fashion, generates ultrasonic waves at the frequency of the transmitter excitation voltage.

The ultrasonic waves may travel towards a target object, such as a finger, passing through the platen 306. A portion of the ultrasonic waves not absorbed or transmitted by the target object may be reflected back through the platen 306 and received by the ultrasonic receiver 310, which, in the implementation illustrated in FIG. 4, overlies the ultrasonic transmitter 308. The ultrasonic receiver 310 may include an array of sensor pixel circuits 432 disposed on a substrate 434 and a piezoelectric receiver layer 436. In some implementations, each sensor pixel circuit 432 may include one or more TFT or CMOS transistor elements, electrical interconnect traces and, in some implementations, one or more additional circuit elements such as diodes, capacitors, and the like. Each sensor pixel circuit 432 may be configured to convert an electric charge generated in the piezoelectric receiver layer 436 proximate to the pixel circuit into an electrical signal. Each sensor pixel circuit 432 may include a pixel input electrode 438 that electrically couples the piezoelectric receiver layer 436 to the sensor pixel circuit 432.

In the illustrated implementation, a receiver bias electrode 440 is disposed on a side of the piezoelectric receiver layer 436 proximal to the platen 306. The receiver bias electrode 440 may be a metallized electrode and may be grounded or biased to control which signals may be passed to the array of sensor pixel circuits 432. Ultrasonic energy that is reflected from the exposed (upper/top) surface 442 of the platen 306 may be converted into localized electrical charges by the piezoelectric receiver layer 436. These localized charges may be collected by the pixel input electrodes 438 and passed on to the underlying sensor pixel circuits 432. The charges may be amplified or buffered by the sensor pixel circuits 432 and provided to the processing unit. The processing unit may be electrically connected (directly or indirectly) with the first transmitter electrode 424 and the second transmitter electrode 426, as well as with the receiver bias electrode 440 and the sensor pixel circuits 432 on the substrate 434. In some implementations, the processing unit may operate substantially as described above. For example, the processing unit may be capable of processing the signals received from the sensor pixel circuits 432.

Some examples of suitable piezoelectric materials that can be used to form the piezoelectric transmitter layer 422 or the piezoelectric receiver layer 436 include piezoelectric polymers having appropriate acoustic properties, for example, an acoustic impedance between about 2.5 MRayls and 5 MRayls. Specific examples of piezoelectric materials that may be employed include ferroelectric polymers such as polyvinylidene fluoride (PVDF) and polyvinylidene fluoride-trifluoroethylene (PVDF-TrFE) copolymers. Examples of PVDF copolymers include 60:40 (molar percent) PVDF-TrFE, 70:30 PVDF-TrFE, 80:20 PVDF-TrFE, and 90:10 PVDR-TrFE. Other examples of piezoelectric materials that may be utilized include polyvinylidene chloride (PVDC) homopolymers and copolymers, polytetrafluoroethylene (PTFE) homopolymers and copolymers, and diisopropylammonium bromide (DIPAB).

The thickness of each of the piezoelectric transmitter layer 422 and the piezoelectric receiver layer 436 is selected so as to be suitable for generating and receiving ultrasonic waves, respectively. In one example, a PVDF piezoelectric transmitter layer 422 is approximately 28 μm thick and a PVDF-TrFE receiver layer 436 is approximately 12 μm thick. Example frequencies of the ultrasonic waves may be in the range of about 1 Megahertz (MHz) to about 100 MHz, with wavelengths on the order of a millimeter or less.

### Point Spread Function Estimation and Deconvolution

As described above, ultrasonic images have traditionally suffered from one, some or all of low image quality, low signal-to-noise ratio (SNR), low resolution, low contrast, attenuation and speckle noise, especially in the context of devices having ultrasonic sensors with thicker platens. Ultrasonic fingerprint images in particular have suffered from image blurring artifacts in the form of, for example, clouding and phase inversion defects or other distortions. Such distortions may result from the passage of the ultrasonic waves as these waves pass through the platen overlying the ultrasonic transducer of the fingerprint sensor onto which the finger is pressed during an ultrasonic imaging operation. As the ultrasonic waves propagate through the platen or other physical media, the waves may be subjected to beam spreading, refraction, diffraction and interference resulting in distortion. As a person having ordinary skill in the art will appreciate, not only are the incident scanning ultrasonic waves transmitted from the ultrasonic transducer of the ultrasonic sensing system subject to such beam spreading, refraction, diffraction and interference, but so too are the received waves reflected off the finger and sensed by the ultrasonic transducer of the ultrasonic sensing system.

Expressed in mathematical terms, the distorted measured image obtained via the reflected ultrasonic waves may be characterized as resulting from the convolution of a true image (the acoustic spatial impedance variations of the finger which define the fingerprint) with a point spread function (PSF) associated with the imaging operation. Equation 1A below represents the convolution:

g(x,y)=f(x,y)*h(x,y)+n(x,y) (1A)

where g(x, y) is the raw measured image of the fingerprint (the distorted image), f(x, y) is the true image of the fingerprint absent distortion, h(x, y) is the PSF, and n(x, y) represents random additive noise. Because the measured image g(x, y) may be characterized as a convolved image resulting from the convolution of the true image f(x, y) with the PSF h(x, y), the distortion in the measured image g(x, y) may be removed by deconvolving the PSF h(x, y) from the measured image g(x, y) (also referred to herein as PSF deconvolution). The resultant deconvolved image ideally represents the true image f(x, y). However, the PSF h(x, y) is generally unknown and dependent on a multitude of factors. Consequently, the PSF h(x, y) must be estimated to enable the deconvolution.

The PSF h(x, y) may be dependent on a number of factors associated with the fingerprint sensor itself (the ultrasonic sensing system) as well as other factors associated with the imaging operation. For example, the PSF h(x, y) may include an electroacoustical component associated with the ultrasonic transducer of the ultrasonic sensing system, a platen component associated with the platen, and a tissue component associated with the finger. The platen component may be dependent on the material properties of the platen as well as geometrical properties (for example, the thickness) of the platen. For example, the material properties of the platen may determine the propagation speed of the ultrasonic waves through the platen. The PSF h(x, y) may be dependent on the color or other properties of a paint or pigment, if any, applied on or otherwise introduced in the platen, along with any adhesive layers, matching layers or other coating layers that may be associated with the ultrasonic sensor. The PSF h(x, y) may be dependent on the frequency of the ultrasonic waves used in the ultrasonic imaging operation. Estimating the PSF h(x, y) is further complicated by the fact that some factors are dynamic; that is, they may change over time. As such, the PSF h(x, y) may in some cases more accurately be expressed as h(x, y, t). For example, the material properties of the platen may change as a function of temperature. The bias voltages associated with the thin-film transistors (TFTs) or CMOS transistors of the driving and sensing circuits associated with the ultrasonic transducer may be temperature dependent. Other examples of factors that may be temperature dependent include the resonant frequencies of the piezoelectric layers of the ultrasonic transducer as well as the optimal acquisition time window (also referred to as the range-gate window (RGW)) and the acquisition time delay (also referred to as the range-gate delay (RGD)), among others. Additionally, the optimal scanning frequency, RGD and RGW may be dependent on the spatial frequencies associated with the fingerprint, which are typically different for men, women and children, and generally different for fingers of different sizes or shapes.

As described above, some implementations relate to devices, systems and methods for estimating a PSF associated with an imaging operation, including a component associated with an ultrasonic sensing system. Some implementations more specifically relate to devices, systems and methods for estimating the PSF on a dynamic basis, and in some particular implementations, in real time. Some implementations further relate to devices, systems and methods for removing distortion from a measured fingerprint image based on the estimated PSF. In some implementations, the estimation of the PSF and the removal of the distortion from the measured fingerprint image based on the estimated PSF may be characterized as two general stages of operations.

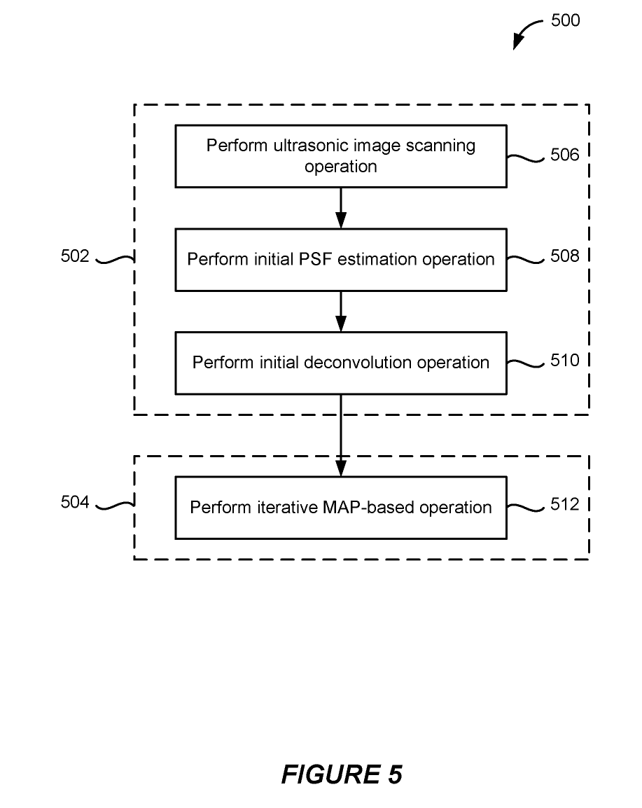

FIG. 5 shows a flowchart illustrating an example process 500 for identifying an object signature according to some implementations. For example, the object may be a human finger and the object signature may be a fingerprint of the finger. In such a fingerprint context, the process 500 (hereinafter also referred to as the object signature identification process 500) includes removing distortion from a distorted fingerprint image to obtain a true image of the fingerprint with the distortion removed. As initially described above, the process 500 may be characterized for didactic purposes as involving two stages of operations. The first stage 502 of the process 500 may include operations to estimate a PSF h(x, y) associated with an ultrasonic imaging operation based on a measured image g(x, y) obtained as a result of the ultrasonic imaging operation. The second stage 504 of the process 500 may include operations to remove the distortion to obtain the true image f(x, y) of the fingerprint based on the estimation of the PSF h(x, y) determined from the first stage 502.

In some implementations, the first stage 502 may be configured to determine an initial estimate of a PSF associated with an ultrasonic image scanning operation that may be based on at least one measured image of the object from an ultrasonic image scanning operation. The first stage 502 may be configured to determine an initial estimate of a deconvolved image of the object, for example, based on the initial estimate of the initial estimate of the PSF. The second stage 504 may be configured to determine a refined estimate of the deconvolved image of the object, for example, using an iterative deconvolution operation based on the initial estimate of the PSF and the initial estimate of the deconvolved image.

In some implementations, the first stage 502 begins in block 506 with the ultrasonic sensing system performing an ultrasonic image scanning operation including one or more image scans of the object (for example, a human finger) to obtain at least one measured image g(x, y) of the object. In some implementations, the first stage 502 proceeds in block 508 with the processing unit of the ultrasonic sensing system performing an initial PSF estimation operation using the at least one measured image g(x, y) to obtain an initial estimate of the PSF hₑₛₜ (x, y) associated with the image scanning operation. In some implementations, the process 500 proceeds in block 510 with the processing unit performing an initial deconvolution operation using the initial estimate of the PSF hₑₛₜ (x, y) to obtain an initial estimate fₑₛₜ(x, y) of a deconvolved image of the object. Blocks 506-510 may be characterized as constituting the first stage 502 of the process 500. The second stage 504 of the process 500 includes performing, in block 512, an iterative maximum a posteriori (MAP)-based operation based on the initial estimate hₑₛₜ(x, y) of the PSF obtained in block 508 and the initial estimate fₑₛₜ(x, y) of the deconvolved image obtained in block 510 to obtain a final refined estimate h_{Final} (x, y) of the PSF and to obtain a final refined estimate f_{Final} (x, y) of the deconvolved image of the object (substantially or ideally representative of the true fingerprint image with distortion removed).

### First Stage

### Image Scanning Operation

As described above, the ultrasonic image scanning operation performed in block 506 may include performing, using the ultrasonic sensing system, multiple ultrasonic image scans of a fingerprint to obtain multiple respective raw measured images g_{raw} (x, y) of the fingerprint. The obtainment of multiple raw measured images g_{raw} (x, y) can, for example, be used to improve a signal-to-noise ratio (SNR). In some implementations, the image scanning operation performed in block 506 includes the performance of multiple image scans at a scanning frequency fₛ over a time duration of, for example, about 2 to 200 milliseconds (ms) per scan. For example, the ultrasonic image scanning operation performed in block 506 may include the performance of 1, 2, 3, 4, 5 or more ultrasonic image scans at the scanning frequency fₛ to obtain a respective number of raw measured images g_{raw} (x, y) at the scanning frequency. In some implementations, the image scanning operation performed in block 506 may additionally or alternatively include the performance of one or more image scans at each of multiple different scanning frequencies to obtain a respective number of raw measured images g_{raw} (x, y) at each of the different scanning frequencies. For example, in some such implementations the ultrasonic sensing system may perform a first set of one or more image scans at a first scanning frequency, a second set of one or more image scans at a second scanning frequency and a third set of one or more image scans at a third scanning frequency. For example, the first scanning frequency may be approximately 9.25 MHz, the second scanning frequency may be approximately 10 MHz, and the third scanning frequency may be approximately 12 MHz. In some other implementations, more or fewer than three scanning frequencies can be used.

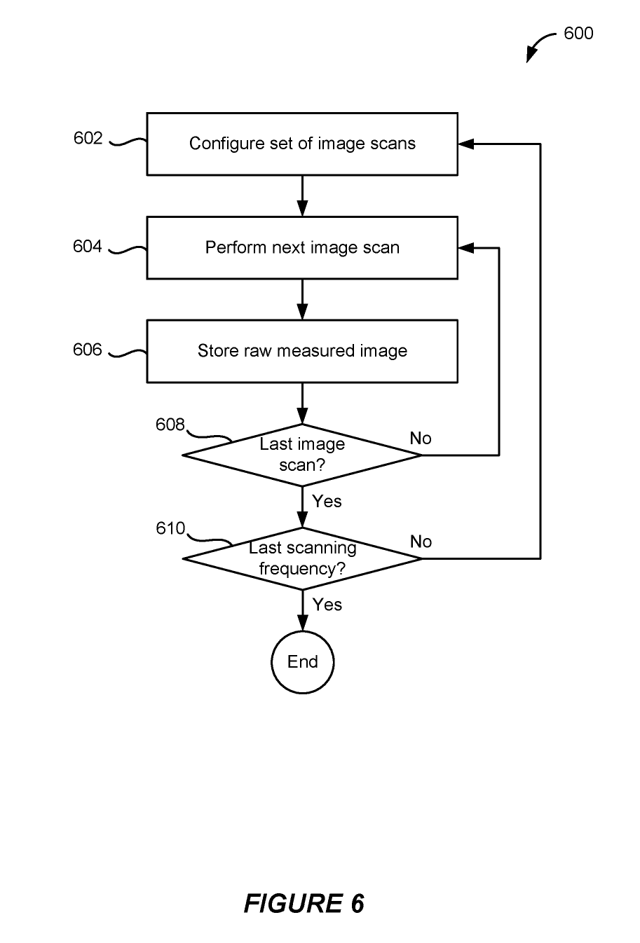

FIG. 6 shows a flowchart illustrating an example process 600 for performing an ultrasonic image scanning operation according to some implementations. For example, the process 600 may implement the ultrasonic image scanning operation performed in block 506 of the process 500. The process 600 (hereinafter also referred to as the image scanning process 600) may include configuring, by the processing unit, first scanning settings for a first set of image scans in block 602. For example, the first scanning settings may include a scanning frequency of the to-be-generated ultrasonic waves, an amplitude of the to-be-generated ultrasonic waves, a start time of the to-be-generated ultrasonic waves, and a time duration of the to-be-generated ultrasonic waves, among other possible scanning settings. In some implementations in which each set of image scans includes multiple image scans, the scanning settings may include a time duration of an interval between successive scans in the set of image scans as well as a number of image scans in the set of image scans. The process 600 proceeds in block 604 with the processing unit causing the ultrasonic sensing system to perform the first image scan of the fingerprint according to the first scanning settings. In block 606, the raw measured image g_{raw}(x, y) obtained from the image scan may be stored in a memory, for example, in the memory 222.

In block 608, the processing unit determines whether the most recently performed image scan was the last image scan in the current set of image scans. If the processing unit determines, in block 608, that the most recently performed image scan was not the last image scan in the current set of image scans, the process 600 returns to block 604 during which a next image scan in the set of image scans is performed. If the processing unit determines, in block 608, that the most recently performed image scan was the last image scan in the current set of image scans, the processing unit then determines, in block 610, whether the most recently performed set of image scans was the last set of image scans to be performed (in other words, whether other images scans should be performed at other scanning frequencies). If the processing unit determines, in block 610, that the most recently performed set of image scans was not the last set of image scans, the process 600 returns to block 602 during which the scanning settings for the next set of image scans are configured. If the processing unit determines in block 610 that the most recently performed set of image scans was the last set of image scans, the process 600 ends.

### Initial PSF Estimation and Deconvolution

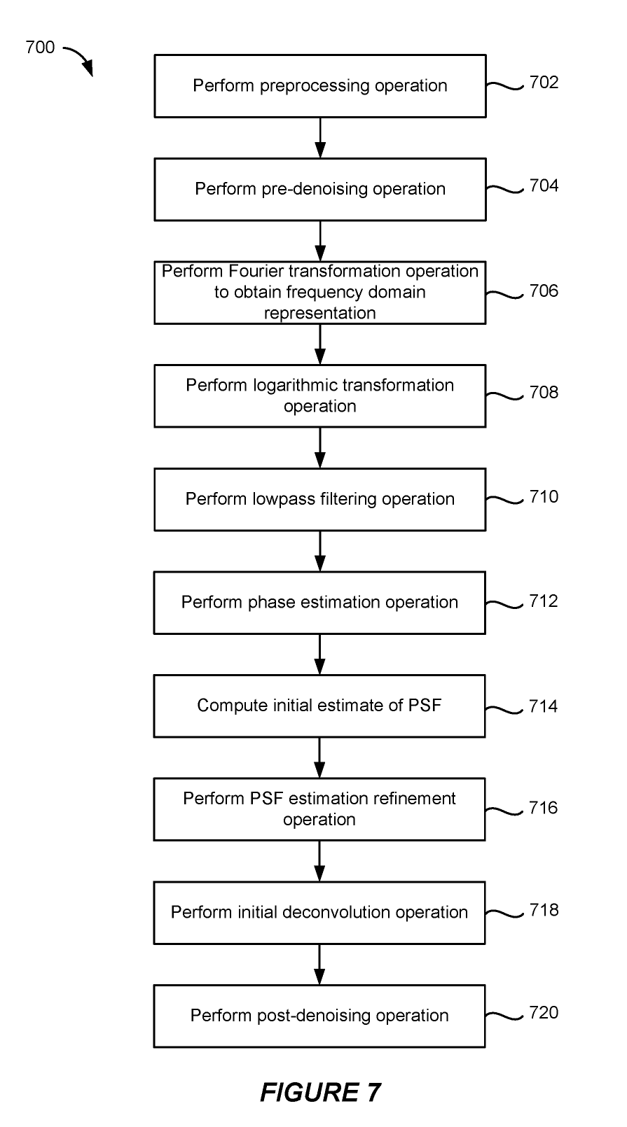

As indicated above, the initial PSF estimation operation performed in block 508 of the process 500 generally includes obtaining an initial estimate of a PSF hₑₛₜ(x, y) associated with the ultrasonic image scanning operation performed in block 506. FIG. 7 shows a flowchart illustrating an example process 700 for performing an initial PSF estimation operation according to some implementations. The process 700 may implement the initial PSF estimation operation of block 508 of the process 500.

### Pre-Processing

In some implementations, the process 700 (hereinafter also referred to as the initial PSF estimation process 700) may include performing, by the processing unit, an initial preprocessing operation 702. In some implementations, the preprocessing operation 702 may include selecting a best image of the raw measured images g_{raw}(x, y) obtained from the ultrasonic image scanning operation of block 506. For example, the processing unit may select the one of the raw measured images g_{raw}(x, y) having the greatest (best) SNR and use the selected raw measured image as the resultant measured image for use in the subsequent blocks of the process 700.

In some implementations in which multiple raw measured images g_{raw}(x, y) are obtained at each of multiple scanning frequencies, the processing unit may select the one of the raw measured images having the greatest SNR at each of the multiple scanning frequencies from the multiple raw measured images obtained at the respective frequencies. In some such implementations, the processing unit may then proceed to average the selected raw measured images g_{raw}(x, y) at the different scanning frequencies to obtain a single resultant averaged image for use in the subsequent blocks of the process 700. In some other such implementations in which multiple raw measured images g_{raw}(x, y) are obtained at each of multiple scanning frequencies, the processing unit may proceed to carry out the remaining subsequent blocks of the process 700 on each of the selected raw measured images in parallel. In some other implementations in which multiple raw measured images g_{raw}(x, y) are obtained at each of multiple scanning frequencies, the processing unit may, for each of the different scanning frequencies, perform a time-compensated average of the raw measured images for the respective frequency to obtain a single resultant averaged measured image for the respective frequency. In some such implementations, the processing unit may then proceed to perform the remaining subsequent blocks of the process 700 on each of the resultant averaged images in parallel. In some other such implementations, the processing unit may select the one of the resultant averaged images having the best SNR as a single resultant measured image for use in the remaining subsequent blocks of the process 700. Hereinafter, the one or more selected or averaged measured images obtained as a result of the completion of the preprocessing operation performed in block 702 will collectively be referred to as “the resultant measured image g_{Res}(x, y).”

### Pre-Denoising

In some implementations, the process 700 may optionally include performing, by the processing unit, an initial pre-denoising operation 704 on the resultant measured image g_{Res}(x, y). For example, the processing unit may perform the pre-denoising operation 704 on each of the one or more resultant selected or averaged measured images obtained as a result of the preprocessing operation performed in block 702. In some implementations, the pre-denoising operation 704 may include one or more denoising operations (also referred to generally as “signal processing operations” or “image processing operations”) including one or more filtering operations. For example, the denoising operations may include one or more of a billet denoising operation, a principal component analysis (PCA) denoising operation, a wavelet filtering operation, or a spatial filtering operation.

### Frequency Domain Transformation

The process 700 proceeds in block 706 with the processing unit performing a Fourier transform operation on the resultant measured image g_{Res}(x, y) to obtain a spatial frequency domain representation G_{Res}(u, v) of the measured image, where u and v are spatial frequencies associated with the x and y directions, respectively. For example, the processing unit may compute a Fourier transform of each of the one or more resultant selected or averaged measured images obtained as a result of the preprocessing operation performed in block 702 (or each of the denoised images in implementations in which the optional pre-denoising operation is performed in block 704). In some implementations, to compute the Fourier transform of the resultant measured image g_{Res}(x, y), the processing unit computes a two-dimensional fast Fourier transform (FFT) of the resultant measured image. Equation 1B below shows the relation of Equation 1A expressed in the spatial frequency domain:

G(u,v)=F(u,v)+N(u,v) (1B)

where

G(u,v)=|G(u,v)|e^{i(angle(G(u,v)))},

F(u,v)=|F(u,v)|e^{i(angle(F(u,v)))},

and

H(u,v)=|H(u,v)|e^{i(angle(H(u,v)))},

and where |G(u, v)|, |F(u, v)| and |H(u, v)| represent the amplitudes of G(u, v), F(u, v) and H(u, v), respectively, and where angle(G(u, v)), angle(F(u, v)) and angle(H(u, v)) represent the phases of G(u, v), F(u, v) and H(u, v), respectively. As indicated above, G(u, v) is taken to be the frequency domain representation G_{Res}(u, v) of the resultant measured image g_{Res}(x, y).

### Homomorphic Transformation

The process 700 proceeds in block 708 with the processing unit performing a logarithmic transformation operation on the frequency domain representation G_{Res}(u, v). For example, the processing unit may compute the logarithm of the frequency domain representation G_{Res}(u, v) to obtain a logarithmic representation log|G_{Res} (u, v)|. Equation 1C below shows the relation of Equation 1B expressed in the complex-cepstrum domain (assuming the logarithm of the noise term N(u, v) is negligible):

\hat{g}(x,y)=\hat{f}(x,y)+\hat{h}(x,y) (1C)

where

\hat{g}(x,y)=IFT(log G(u,v)),

\hat{f}(x,y)=IFT(log F(u,v)),

and

\hat{h}(x,y)=IFT(log H(u,v))

and where IFT denotes the inverse Fourier transform. Here again, as indicated above, ĝ(x, y) is taken to be the complex-cepstrum representation ĝ_{Res}(x, y) of the resultant measured image g_{Res}(x, y). Equations 2A and 2B below show the relationships of the amplitudes and phases of Equation 1C:

log|G_{Res}(u,v)|=log|F(u,v)|+log|H(u,v)|, (2A)

angle(G_{Res}(u,v))=angle(F(u,v))+angle(H(u,v)). (2B)

In block 710, the processing unit performs a lowpass filtering operation on the logarithmic representation log|G_{Res}(u, v)| to obtain a filtered representation of the logarithmic representation. In some implementations, performing the lowpass filtering operation includes performing a wavelet denoising operation such as a discrete wavelet transform (DWT) filtering operation. For example, the processing unit may compute a DWT of the logarithmic representation log|G_{Res}(u, v)| using any suitable wavelet such as, for example, the Daubechies wavelet Db-4. The processing unit may then perform a soft thresholding operation on the computed DWT and subsequently perform an inverse DWT to complete the wavelet denoising operation.

In some implementations, the process 700 proceeds in block 712 with the processing unit performing a phase estimation operation on the phase representation angle(G_{Res}(u, v)) to obtain an initial phase estimation of the phase of angle(G_{Res}(u, v)). The phase estimation operation may include performing a short median filtering operation on angle(G_{Res}(u, v)). In some implementations, the phase estimation operation may include a phase unwrapping operation. In some implementations, the phase unwrapping for the non-minimum phase PSF involves taking the 1^{st} order derivative of the phase, and then projecting the phase derivative to a pre-defined low resolution subspace, and subsequently performing smooth filtering of the projected phase.

In some implementations, the process 700 proceeds in block 714 with the processing unit computing an initial estimate hₑₛₜ(x, y) of the PSF. For example, computing the initial estimate hₑₛₜ(x, y) of the PSF may include computing an inverse fast Fourier transform (IFFT) of log G_{Res}(u, V) after the lowpass (for example, wavelet) filtering operation of block 710 and after the phase estimation operation of block 712. The result of the IFFT is the complex-cepstrum domain representation ĝ_{Res}(x, y)=IFFT(log G_{Res}(u, v)). As such, the performance of blocks 706-712 result in a homomorphic transformation of the spatial domain representation of the resultant measured image g_{Res}(x, y) into a complex-cepstrum domain representation ĝ_{Res}(x, y). Assuming that F(u, v) and H(u, v) exist in different frequency bands, Equation 1C may be approximated as:

ĝ_{Res}(x,y)=\hat{h}(x,y)

As such, after the wavelet denoising and phase estimation operations performed in blocks 710 and 712, respectively, a complex-cepstrum domain representation of an initial estimate hₑₛₜ(x, y) of the PSF may be approximated as being equal to the complex-cepstrum domain representation of the resultant measured image, ĝ_{Res}(x, y). As such, in some implementations, the processing unit computes an initial estimate of the transfer function Hₑₛₜ(u, v) as provided in Equation 3A below:

Hₑₛₜ(u,v)=|G_{Res}(u,v)|e^{i(angle(G}^{_{Res}}^{(u,v)}. (3A)

An initial estimate hₑₛₜ(x, y) of the PSF may then be computed in block 714 according to Equation 3B below:

hₑₛₜ(x,y)=IFFT(|G_{Res}(u,v)|e^{i(angle(G}^{_{Res}}^{(u,v))}). (3B)

where IFFT denotes the inverse two-dimensional fast Fourier transform.

### Refinement of Initial PSF Estimate

In some implementations, the process 700 proceeds in block 716 with the processing unit performing a PSF estimation refinement operation to obtain an initial refined or enhanced initial estimate h_{Ref} (x, y) of the PSF. For example, the refinement operation may include performing an iterative expectation maximization (EM)-based operation on the initial estimate hₑₛₜ (x, y) of the PSF (from Equation 3B) to obtain the refined initial estimate h_{Ref} (x, y) of the PSF. In some implementations, performing the iterative EM-based operation includes determining a first spatial variance σₓ along the x axis and a second spatial variance σ_{y} along the y axis. In some implementations, to perform the EM-based operation, the initial estimate hₑₛₜ(x, y) of the PSF is modeled as a Gaussian parametric model. In some such implementations, the iterative EM-based operation may include fitting the initial estimate hₑₛₜ(x, y) of the PSF to a multi-Gaussian parametric model, for example, the module shown in Equation 4A below:

$${h}_{est} ( x , y ) = {e}^{- ( \frac{{x}^{2}}{2 {σ}_{x}^{2}} + \frac{{y}^{2}}{2 {σ}_{y}^{2}} )} . \qquad ( 4 A )$$

In some other implementations, the iterative EM-based operation includes fitting the initial estimate hₑₛₜ(x, y) of the PSF to a cosine-modulated Gaussian parametric model, for example, the module shown in Equation 4B below:

$${h}_{est} ( x , y , t ) = {Ae}^{- ( \frac{{x}^{2}}{2 {σ}_{x}^{2}} + \frac{{y}^{2}}{2 {σ}_{y}^{2}} )} cos ( 2 π {f}_{s} ( t \cdot \frac{\sqrt{{x}^{2} + {y}^{2}}}{c} ) ) , \qquad ( 4 B )$$

where A represents an amplitude, where fₛ represents the scanning frequency associated with the image g_{Res}(x, y), where c represents the speed of the ultrasonic waves in the platen, and where t represents time. Generally, the model used in the iterative EM-based operation may be selected and optimized based on the shape of the PSF estimate hₑₛₜ(x, y) from Equation 3A.

### Initial Deconvolution Operation

In some implementations, the process 700 proceeds in block 718 with the processing unit performing an initial deconvolution operation using the refined initial estimate h_{Ref} (x, y) of the PSF to obtain an initial estimate fₑₛₜ(x, y) of the true (deconvolved) image f(x, y). In some such implementations, the initial deconvolution operation includes a pseudo-inversion operation, for example, a Wiener filter deconvolution operation. In the present context, the Wiener filter, expressed as w(x, y), may be defined as the function that provides the estimate fₑₛₜ(x, y) of the true image f(x, y) that minimizes the mean square error. The relationship in the present context is expressed as Equation 5A below:

fₑₛₜ(x,y)=w(x,y)*g_{Res}(x,y), (5A)

which may be expressed in the frequency domain as Equation 5B below:

Fₑₛₜ(u,v)=W(u,v)G_{Res}(u,v) (5B),

where Fₑₛₜ(u, v), W(u, v) and G_{Res}(u, v) are the Fourier transforms of fₑₛₜ(x, y), w(x, y) and g_{Res}(x, y), respectively.

W(u, v) may be expressed as Equation 6A below:

$$W ( u , v ) = \frac{{H}_{Ref}^{*} ( u , v ) P ( u , v )}{{\vert {H}_{Ref} ( u , v ) \vert}^{2} P ( u , v ) + D ( u , v )} , \qquad ( 6 A )$$

where H*_{Ref} (u, v) denotes the complex conjugate of H_{Ref}(u, v), and where P(u, v) and D(u, v) are the mean power spectral densities of f(x, y) and n(x, y), respectively. Equation 6A may be rewritten as Equation 6B below:

$$W ( u , v ) = \frac{{H}_{Ref}^{*} ( u , v )}{{\vert {H}_{Ref} ( u , v ) \vert}^{2} + \frac{1}{SNR ( u , v )}} , \qquad ( 6 B )$$

where

$$SNR ( u , v ) = \frac{P ( u , v )}{D ( u , v )} ,$$

the signal-to-noise ratio as a function of spatial frequencies u and v. In some implementations, the SNR(u, v) term may be estimated from the measurements or estimated empirically.

Substituting Equation 6B into Equation 5B yields Equation 7A below:

$${F}_{est} ( u , v ) = \frac{{G}_{Res} ( u , v ) {H}_{Ref}^{*} ( u , v )}{{\vert {H}_{Ref} ( u , v ) \vert}^{2} + \frac{1}{SNR ( u , v )}} . \qquad ( 7 A )$$

The estimate fₑₛₜ(x, y) of the true image f(x, y) may thus be obtained in block 718 by taking the inverse Fourier transform (for example, the inverse two-dimensional fast Fourier transform) as shown below in Equation 7B:

$${f}_{est} ( x , y ) = IFFT ( \frac{{G}_{Res} ( u , v ) {H}_{Ref}^{*} ( u , v )}{{\vert {H}_{Ref} ( u , v ) \vert}^{2} + \frac{1}{SNR ( u , v )}} ) . \qquad ( 7 B )$$

### Post-Denoising

In some implementations, the process 700 may optionally include performing, by the processing unit, a second post-denoising operation 720 on the estimate fₑₛₜ(x, y) obtained in block 718. For example, in implementations in which blocks 704-718 are performed for each of multiple resultant images g_{Res}(x, y), the processing unit may perform the post-denoising operation 720 on each of the multiple corresponding estimates of the true image obtained as a result of the initial deconvolution operation performed in block 718. In some implementations, the post-denoising operation performed in block 720 may include one or more denoising operations (also referred to generally as “signal processing operations” or “image processing operations”) including one or more filtering operations. For example, the denoising operations may include one or more of a billet denoising operation, a principal component analysis (PCA) denoising operation, a wavelet filtering operation, or a spatial filtering operation.

### Second Stage

### MAP-Based Estimation Operation Using ALM

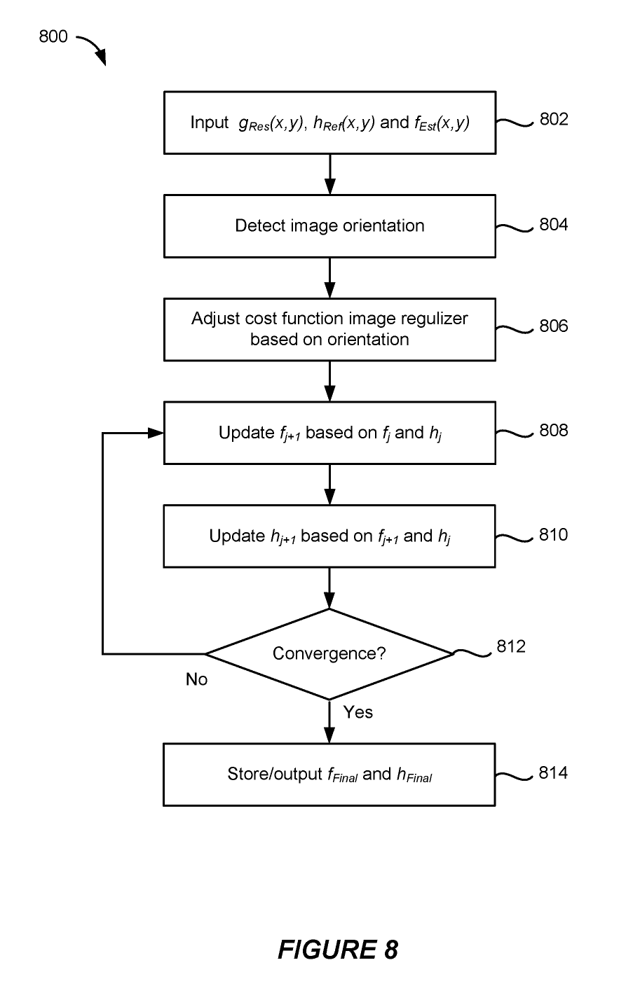

As indicated above with reference to the process 500, the iterative maximum a posteriori (MAP)-based operation performed in block 512 of the process 500 generally includes obtaining a final refined estimate h_{Final} (x, y) of the PSF and a final refined estimate f_{Final} (x, y) of the deconvolved image of the object (substantially or ideally representative of the true fingerprint image with distortion removed) based on the initial estimate hₑₛₜ(x, y) of the PSF obtained in block 508 and the initial estimate fₑₛₜ(x, y) of the deconvolved image obtained in block 510. FIG. 8 shows a flowchart illustrating an example process 800 for performing an iterative MAP-based operation according to some implementations.

The MAP-based operation performed by the processing unit in the process 800 involves the joint recovery of both the final refined estimate h_{Final} (x, y) of the PSF h(x, y) and the final refined estimate f_{Final} (x, y) of the true image f(x, y). In probabilistic terms, the MAP-based operation includes maximizing the posterior probability, expressed as Equation 8 below (in which the arguments x and y are not shown for simplicity):

P(f,h|g)∝P(g|f,h)P(f,h)=P(g|f,h)P(f)P(h), (8)

where P(f, h|g) is the posterior probability (or simply the “posterior”) representing the probability of the latent image f and the latent PSF h given the measured image g. Additionally, P(g|f, h) represents the probability of the measured image g given the true image f and the true PSF h; P(f) represents the prior probability distribution associated with the latent image; and P(h) represents the prior probability distribution associated with the latent PSF.

As described above, at a high level, the process 800 involves maximizing the posterior in Equation 8, which may be characterized and treated as a non-convex optimization problem. Assuming that the function P(g|f, h) is Gaussian, it may be advantageously expressed as Equation 9:

$$P ( g \vert f , h ) ∝ {e}^{( - \frac{γ}{2} {‖ f * h - g ‖}_{2}^{2} )} , \qquad ( 9 )$$

where ∥f*h−g∥₂ represents the norm of f*h−g, and where γ is an empirically-based number selected to aid in convergence (described below).

Because maximizing the posterior is equivalent to minimizing its negative logarithm, the maximization of the posterior may be obtained through minimizing a cost function. In some implementations, the cost function that is minimized in the process 800 is an augmented Lagrangian method (ALM)-based cost function, such as that shown in Equation 10 below:

$$L ( f , h ) = - log ( P ( f , h \vert g ) ) + κ = \frac{γ}{2} {‖ f * h - g ‖}_{2}^{2} + Q ( f ) + R ( h ) + κ , \qquad ( 10 )$$

where Q(f)=−log P(f), R(h)=−log P(h), and where κ is a constant related to the SNR. The terms Q(f) and R(h) are referred to as the image regulizer and the PSF regulizer, respectively. For example, the image regulizer Q(f) may be expressed as Equation 11 below:

$$Q ( f ) = Φ ( {D}_{x} f , {D}_{y} f ) = {\sum }_{i} {( {{w}_{x} [ {D}_{x} f ]}_{i}^{2} + {{w}_{y} [ {D}_{y} f ]}_{i}^{2} )}^{\frac{p}{2}} , \qquad ( 11 )$$

where 0≦p≦1, where Dₓ and D_{y} are image gradients along the x and y axes, respectively, and where wₓ and w_{y} are weights based on the orientation of the fingerprint. These regularization parameters may be empirically chosen in some implementations.

In some implementations, the PSF regulizer may be expressed as Equation 12 below:

R(h)=ΣᵢΨ(hᵢ), (12)

where

$$Ψ ( {h}_{i} ) = \{ \begin{matrix}{h}_{i} , {h}_{i} \geq 0 + \\ ∞ , {h}_{i} < 0\end{matrix} \} .$$

In some implementations, the process 800 begins in block 802 with the processing unit initializing initial values of the measured image, the PSF and the actual image. In some implementations, the processing unit uses the values obtained as a result of the completion of the process 700 described with reference to FIG. 7. In such implementations, the processing unit initializes the values of the measured image as g_{Res}(x, y), the values of the PSF as h_{Ref}(x, y), and the values of the deconvolved image as fₑₛₜ(x, y). In some implementations, the process 800 proceeds in block 804 with the processing unit detecting an orientation of the initial estimate fₑₛₜ(x, y) of the true fingerprint image, and adjusting the image regulizer Q(f) based on the detected orientation in block 806.

Minimizing the ALM-based cost function of Equation 10 includes alternately minimizing the ALM-based cost function with respect to values of the deconvolved image and values of the PSF subject to a constraint that the square of the norm of the convolution of the latest estimate of the deconvolved image and the latest estimate of the PSF less the at least one measured image is less than or equal to the constant κ; that is, subject to the constraint shown as Equation 13 below:

∥f*h−g∥₂²≦κ. (13)

In some implementations, to minimize the ALM-based cost function with respect to the deconvolved image, the processing unit minimizes a revised or simplified version of the cost function, for example, shown in Equation 14A below:

$${min}_{f} \frac{γ}{2} {‖ f * h - g ‖}_{2}^{2} + Φ ( {D}_{x} f , {D}_{y} f ) . \qquad ( 14 A )$$

In some implementations in which multiple raw measured images g_{raw}(x, y) are obtained at each of multiple scanning frequencies, the processing unit may minimize the simplified version of the cost function over N input images (the one or more selected or averaged measured images obtained as a result of the completion of the preprocessing operation performed in block 702) as shown in Equation 14B shown below:

$${min}_{f} \frac{γ}{2} {\sum }_{k = 1}^{N} {‖ f * {h}_{k} - {g}_{k} ‖}_{2}^{2} + Φ ( {D}_{x} f , {D}_{y} f ) . \qquad ( 14 B )$$

where gₖ represent the N input images. The processing unit generates, in block 808, an updated estimate of the deconvolved image fⱼ₊₁(x, y) based on a minimization of the cost function of Equation 14B using the previous estimate of the deconvolved image fⱼ(x, y) and the previous estimate of the PSF hⱼ(x, y).

In some implementations, to minimize the ALM-based cost function with respect to the PSF, the processing unit minimizes a revised or simplified version of the cost function, for example, shown in Equation 15 below:

$${min}_{f , h} \frac{γ}{2} {‖ f * h - g ‖}_{2}^{2} + R ( h ) . \qquad ( 15 )$$

Again, in some implementations in which multiple raw measured images g_{raw}(x, y) are obtained at each of multiple scanning frequencies, the processing unit may minimize the simplified version of the cost function shown in Equation 15 over N input images (the one or more selected or averaged measured images obtained as a result of the completion of the preprocessing operation performed in block 702). The processing unit generates, in block 810, an updated estimate of the PSF hⱼ₊₁(x, y) based on a minimization of the cost function of Equation 15 using the latest estimate of the deconvolved image fⱼ₊₁(x, y) and the previous estimate of the PSF hⱼ(x, y).

For example, in a first iteration of the ALM-based cost function minimization operation (each iteration including blocks 808 and 810), the cost function (Equation 14A or 14B) is first minimized in block 808 with respect to f(x, y) taking fₑₛₜ(x, y) as an initial starting point f₁(x, y) and taking h_{Ref} (x, y) as an initial starting point h₁(x, y) for h(x, y) to obtain a refined estimate f₂ (x, y). The cost function (Equation 15) is then minimized in block 810 with respect to h(x, y) taking f₂(x, y) as f(x, y) and taking hₑₛₜ(x, y) as the initial starting point h₁(x, y) for h(x, y) to obtain a refined estimate h₂(x, y). Generally, in each iteration of the ALM-based cost function minimization operation, the ALM-based cost function is again first minimized with respect to f(x, y) taking fⱼ(x, y) as an initial starting point for f(x, y) and taking hⱼ(x, y) as h(x, y) to obtain a refined estimate fⱼ₊₁(x, y), where j indicates the j^{th} iteration. In the same iteration, the cost function is then minimized with respect to h(x, y) taking fⱼ₊₁(x, y) as f(x, y) and taking hⱼ(x, y) as the initial starting point for h(x, y) to obtain a refined estimate hⱼ₊₁(x, y).

After each iteration of the ALM-based cost function minimization operation, the processing unit, in block 812, determines whether there is convergence between fⱼ₊₁(x, y) and fⱼ(x, y) (or hⱼ₊₁(x, y) and hⱼ(x, y)), that is, if the results of the j^{th} iteration converge with the results of the (j−1)^{th} iteration. If the processing unit determines, in block 812, that the results do not converge, the process 800 proceeds back to block 808 with the processing unit performing the next (j+1)^{th} iteration. On the other hand, if the processing unit determines, in block 812, that the results do converge, the process 800 proceeds in block 814 with the processing unit storing or outputting the last values fⱼ₊₁(x, y) and hⱼ₊₁(x, y) as the final estimated values f_{Final}(x, y) and h_{Final}(x, y), respectively. In some implementations, the process 800 further includes performing a morphologic filtering operation on the final estimated values f_{Final}(x, y) of the true image.

### CONCLUSION

Various modifications to the implementations described in this disclosure may be readily apparent to those skilled in the art, and the generic principles defined herein may be applied to other implementations without departing from the spirit or scope of this disclosure. Thus, the following claims are not intended to be limited to the implementations shown herein, but are to be accorded the widest scope consistent with this disclosure, the principles and the novel features disclosed herein.

Additionally, certain features that are described in this specification in the context of separate implementations may be implemented in combination in a single implementation. Conversely, various features that are described in the context of a single implementation may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. Moreover, various ones of the described and illustrated operations may itself include and collectively refer to a number of sub-operations. For example, each of the operations described above may itself involve the execution of a process or algorithm. Furthermore, various ones of the described and illustrated operations may be combined or performed in parallel in some implementations. Similarly, the separation of various system components in the implementations described above should not be understood as requiring such separation in all implementations. As such, other implementations are within the scope of the following claims. In some cases, the actions recited in the claims may be performed in a different order and still achieve desirable results.

What is claimed is:

1. A method for use by a processing unit in obtaining a deconvolved image of an object, comprising:
determining an initial estimate of a point spread function (PSF) associated with an ultrasonic image scanning operation based on at least one measured image of the object from the ultrasonic image scanning operation;
determining an initial estimate of a deconvolved image of the object based on the initial estimate of the PSF; and
determining a refined estimate of the deconvolved image of the object using an iterative deconvolution operation based on the initial estimate of the PSF and the initial estimate of the deconvolved image.

2. The method of claim 1, wherein determining the initial estimate of the PSF includes:
determining at least one spatial frequency domain representation of the at least one measured image by performing a Fourier transform operation on the at least one measured image.

3. The method of claim 2, wherein determining the initial estimate of the PSF further includes:
determining at least one logarithmic representation of the at least one spatial frequency domain representation by performing a logarithmic transformation operation on the at least one spatial frequency domain representation; and
determining a filtered representation of the at least one logarithmic representation by performing a low pass filtering operation on the at least one logarithmic representation.

4. The method of claim 2, wherein determining the initial estimate of the PSF further includes:
determining a phase representation of the at least one spatial frequency domain representation by performing a phase estimation operation on the at least one spatial frequency domain representation.

5. The method of claim 2, wherein determining the initial estimate of the deconvolved image of the object includes:
performing a pseudo-inversion operation based on the at least one spatial frequency domain representation of the at least one measured image.

6. The method of claim 1, wherein determining the initial estimate of the PSF further includes:
enhancing the initial estimate of the PSF using an iterative expectation maximization (EM)-based operation.

7. The method of claim 6, wherein performing the iterative EM-based operation includes:
determining a first spatial variance along an x axis and a second spatial variance along a y axis based on a Gaussian parametric model.

8. The method of claim 1, wherein determining the refined estimate of the deconvolved image of the object using the iterative deconvolution operation includes:
performing an iterative maximum a posteriori (MAP)-based operation using the initial estimate of the PSF and the initial estimate of the deconvolved image.

9. The method of claim 8, wherein performing the iterative MAP-based operation includes:
minimizing an augmented Lagrangian method (ALM)-based cost function, the ALM-based cost function including an image regulizer term, a PSF regulizer term and a term that includes a square of a norm of a convolution of a latest estimate of the deconvolved image and a latest estimate of the PSF less the at least one measured image.

10. The method of claim 9, wherein the minimizing of the ALM-based cost function includes alternately minimizing the ALM-based cost function with respect to a latest estimate of the deconvolved image and a latest estimate of the PSF subject to a constraint that the square of the norm of the convolution of the latest estimate of the deconvolved image and the latest estimate of the PSF less the at least one measured image is less than or equal to a threshold value.

11. A system for use in obtaining a deconvolved image of an object, comprising:
an ultrasonic sensing system configured to perform an ultrasonic image scanning operation including one or more image scans of an object to obtain at least one measured image of the object; and
a processing unit configured to:
determine an initial estimate of a point spread function (PSF) associated with the ultrasonic image scanning operation based on the at least one measured image;
determine an initial estimate of a deconvolved image of the object based on the initial estimate of the PSF; and
determine a refined estimate of the deconvolved image of the object using an iterative deconvolution operation based on the initial estimate of the PSF and the initial estimate of the deconvolved image.

12. The system of claim 11, wherein to determine the initial estimate of the PSF the processing unit is configured to:
determine at least one spatial frequency domain representation of the at least one measured image by performing a Fourier transform operation on the at least one measured image.

13. The system of claim 12, wherein to determine the initial estimate of the PSF the processing unit is further configured to:
determine at least one logarithmic representation of the at least one spatial frequency domain representation by performing a logarithmic transformation operation on the at least one spatial frequency domain representation; and
determine a filtered representation of the at least one logarithmic representation by performing a low pass filtering operation on the at least one logarithmic representation.

14. The system of claim 12, wherein to determine the initial estimate of the PSF the processing unit is further configured to:
determine a phase representation of the at least one spatial frequency domain representation by performing a phase estimation operation on the at least one spatial frequency domain representation.

15. The system of claim 12, wherein to determine the initial estimate of the deconvolved image of the object the processing unit is configured to:
perform a pseudo-inversion operation based on the at least one spatial frequency domain representation of the at least one measured image.

16. The system of claim 11, wherein to determine the initial estimate of the PSF the processing unit is further configured to:
enhance the initial estimate of the PSF using an iterative expectation maximization (EM)-based operation.

17. The system of claim 11, wherein to determine the refined estimate of the deconvolved image of the object using the iterative deconvolution operation the processing unit is configured to:
perform an iterative maximum a posteriori (MAP)-based operation using the initial estimate of the PSF and the initial estimate of the deconvolved image.

18. The system of claim 17, wherein to perform the iterative MAP-based operation the processing unit is configured to:
minimize an augmented Lagrangian method (ALM)-based cost function, the ALM-based cost function including an image regulizer term, a PSF regulizer term and a term that includes a square of a norm of a convolution of a latest estimate of the deconvolved image and a latest estimate of the PSF less the at least one measured image.

19. The system of claim 18, wherein to minimize the ALM-based cost function the processing unit is configured to:
alternately minimize the ALM-based cost function with respect to a latest estimate of the deconvolved image and a latest estimate of the PSF subject to a constraint that the square of the norm of the convolution of the latest estimate of the deconvolved image and the latest estimate of the PSF less the at least one measured image is less than or equal to a threshold value.

20. A non-transitory medium having software stored thereon, the software including instructions for:
determining an initial estimate of a point spread function (PSF) associated with an ultrasonic image scanning operation based on at least one measured image of the object from the ultrasonic image scanning operation;
determining an initial estimate of a deconvolved image of the object based on the initial estimate of the PSF; and
determining a refined estimate of the deconvolved image of the object using an iterative deconvolution operation based on the initial estimate of the PSF and the initial estimate of the deconvolved image.
